(19) United States
(12) Patent Application Publication
(10) Pub. No.: US 2014/0073232 A1
(43) Pub. Date: Mar. 13, 2014

(54) Laterally Assembled Vehicle Duct Joint

(71) Applicants: Lawrence C. Karas, New Boston, MI (US); Mukesh Kumar, Canton, MI (US); Robert Steven Sawyer, Farmington Hills, MI (US); Eric R. Yerke, Redford, MI (US)

(72) Inventors: Lawrence C. Karas, New Boston, MI (US); Mukesh Kumar, Canton, MI (US); Robert Steven Sawyer, Farmington Hills, MI (US); Eric R. Yerke, Redford, MI (US)

(73) Assignee: FORD GLOBAL TECHNOLOGIES, LLC, Dearborn, MI (US)

(21) Appl. No.: 13/611,582

(22) Filed: Sep. 12, 2012

(51) Int. Cl. B60H 1/26

(52) U.S. Cl. 454/143

(57) ABSTRACT

A duct assembly including a first duct and a second duct that are connected by a receptacle and a fitting that are moved in a transverse direction to assemble the first duct to the second duct. The receptacle defines a slot that includes an inner wall and an outer wall. The inner and outer wall define a fitting insertion opening on one lateral side and a fitting seat on the opposite lateral side. A seal is provided on a face wall of the fitting. Triangular side walls extend between the inner and outer walls. A locking tab on a triangular side wall is received within a tab receiver on the outer wall of the fitting.

### TECHNICAL FIELD

This disclosure relates to vehicle heating, ventilating, and air conditioning duct joints for joining two sections of duct work together.

### BACKGROUND

Vehicles include heating, ventilating, and air conditioning (HVAC) duct work that direct airflow into the passenger compartment to maintain a comfortable environment within the passenger compartment of the vehicle. HVAC ducts may be routed from the engine compartment through the dash board, doors and structural members. The ducts are relatively bulky and packaging constraints within the vehicle body may complicate assembly of the ducts in the vehicle.

HVAC ducts are generally assembled in a telescopic manner with one duct end being inserted into another duct end. Telescopically assembled HVAC ducts are assembled by moving one duct relative to another in the direction of airflow. Clearance is required for assembling the ducts together within the confines of the vehicle structure. Packaging constraints in some vehicle locations do not provide sufficient clearance for telescopic assembly of the HVAC ducts.

The above problems and other problems are addressed by this disclosure as summarized below.

### SUMMARY

According to one aspect of this disclosure, a vehicle heating, ventilation and air conditioning (HVAC) duct is provided that comprises a first duct and a second duct for providing airflow between the first duct and the second duct in a first direction. A receptacle is provided on the first duct that defines a V-shaped slot. A fitting is provided on the second duct that is inserted in a transverse direction relative to the first direction into the V-shaped slot.

According to other aspects of this disclosure, the receptacle is disposed about a periphery of the first duct and the fitting is disposed about a periphery of the second duct. A seal may be attached to the fitting that engages an inner wall of the V-shaped slot of the receptacle when the fitting is inserted into the V-shaped slot. The V-shaped slot is defined by an outer wall and the inner wall that together define an opening on a fitting insertion side and intersect on a side of the V-shaped slot against which the fitting is disposed when the fitting is fully installed in the V-shaped slot.

The fitting may include a face wall that faces the inner wall of the V-shaped slot when the fitting is inserted into the V-shaped slot. The seal may be provided on the face wall to prevent the airflow from escaping from the receptacle and the fitting. The seal may be an elastomeric seal that is compressed between the inner wall and the face wall as the fitting is inserted into the V-shaped slot.

According to further aspects of this disclosure, a locking tab may be provided on one of the receptacle and fitting and a tab receiver may be provided on the other one of the receptacle and fitting to selectively lock the fitting to the receptacle. The fitting may include a face wall and two triangular sidewalls that extend between the face wall and the outer wall of the receptacle. A locking tab may be provided on at least one of the sidewalls. The outer portion of the V-shaped receiver defines a tab slot that receives the locking tab to lock the fitting within the receptacle.

The V-shaped slot defined by the receptacle may further comprise a sealing flange that is provided about the first duct, a holding flange oriented at an angle relative to the sealing flange, and first and second spacing walls that connect the sealing flange to the holding flange.

According to an alternative embodiment of this disclosure, a heating, ventilation and air conditioning system duct joint assembly is provided for a first tubular duct and a second tubular duct. The ducts direct airflow through the first tubular duct and the second tubular duct. A receptacle on a receiving end of the first tubular duct may include an inner wall that extends about a first end of the first tubular duct. An outer wall is connected to the inner wall on a first lateral side and is spaced from the inner wall on a second lateral side to define a slot that is closed at the first lateral side and is open on the second lateral side. A fitting on an end of the second duct is inserted into the slot through the second lateral side.

According to other aspects of the above alternative embodiment of the disclosed joint assembly, the receptacle may be disposed about a periphery of the first duct. The fitting is disposed about a periphery of the second duct. The joint assembly may further comprise a seal attached to the fitting that engages an inner wall of the receptacle when the fitting is inserted into the slot. The slot may include an outer wall that defines an opening on a fitting insertion side and that intersects with the inner wall on a side of the slot against which the fitting is disposed when the fitting is fully installed in the slot. The fitting may include a face wall that faces the inner wall of the slot when the fitting is inserted into the slot.

The slot defined by the receptacle may further comprise a sealing flange that is provided about the first duct, a holding flange oriented at an angle relative a sealing flange, and first and second spacing walls that connect the sealing flange to the holding flange.

The above aspects of the disclosure and other aspects will be better understood in view of the attached drawings and the following detailed description of the illustrated embodiment.

### BRIEF DESCRIPTION OF THE DRAWINGS

FIG. 1 is a perspective view of two HVAC ducts that are connected by a joint that is assembled in a direction that is perpendicular to the direction of airflow through the ducts;

FIG. 2 is an elevation view of the two HVAC ducts and joint;

FIG. 3 is a diagrammatic cross-sectional view of a V-shaped slot defined by one part of the joint with a fitting of another part of the joint initially being inserted into the slot;

FIG. 4 is a diagrammatic cross-sectional view of a V-shaped slot defined by one part of the joint with a fitting of another part of the joint being almost completely inserted into the slot; and

FIG. 5 is a diagrammatic cross-sectional view of a V-shaped slot defined by one part of the joint with a fitting of another part of the joint being fully inserted into the slot.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

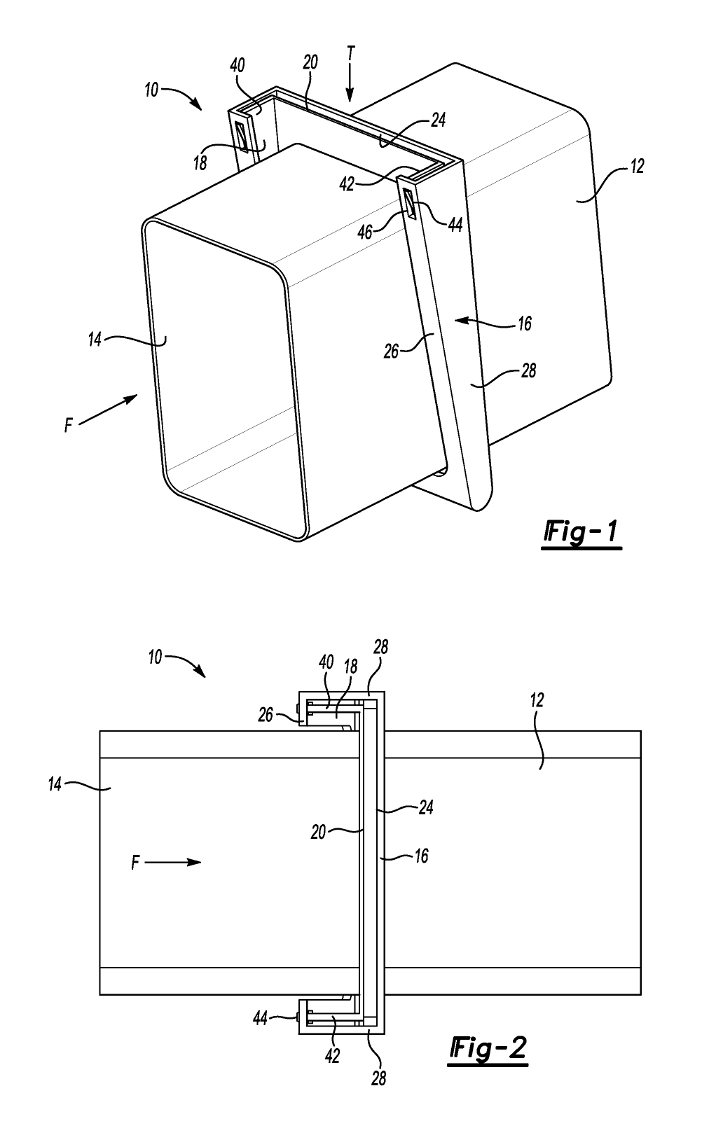

Referring to FIG. 1, a heating ventilation and air conditioning (HVAC) duct assembly 10 is illustrated. A first duct 12 and a second duct 14 are shown joined together. The ducts 12, 14 are tubular members that may be rectangular, square or other hollow cross-sectional shapes. The first duct 12 and second duct 14 each define an open end that are joined together in the assembly 10 to permit airflow.

A receptacle 16 is provided on the first duct 12. The receptacle 16 defines a V-shaped slot 18. A fitting 20 is provided on the second duct 14. The fitting 20 is inserted in the V-shaped slot 18 of receptacle 16 to connect the second duct 14 to the first duct 12. As shown in FIGS. 1 and 2, the first duct 12 and second duct 14 are connected together to allow air to flow in an air flow direction indicated by arrow F. It should be understood that air flow direction F may be reversed. The first duct 12 and second duct 14 are assembled together by moving relative to each other in a transverse direction indicated by the arrow T.

An inner wall 24 of the receptacle 16 defines a sealing flange that extends radially outwardly from the first duct 12. An outer wall 26 of the receptacle 16 is spaced from the inner wall 24 on one lateral side. The inner wall 24 and outer wall 26 intersect on the opposite lateral side. The inner wall 24 and outer wall 26 may be connected by spacing walls 28.

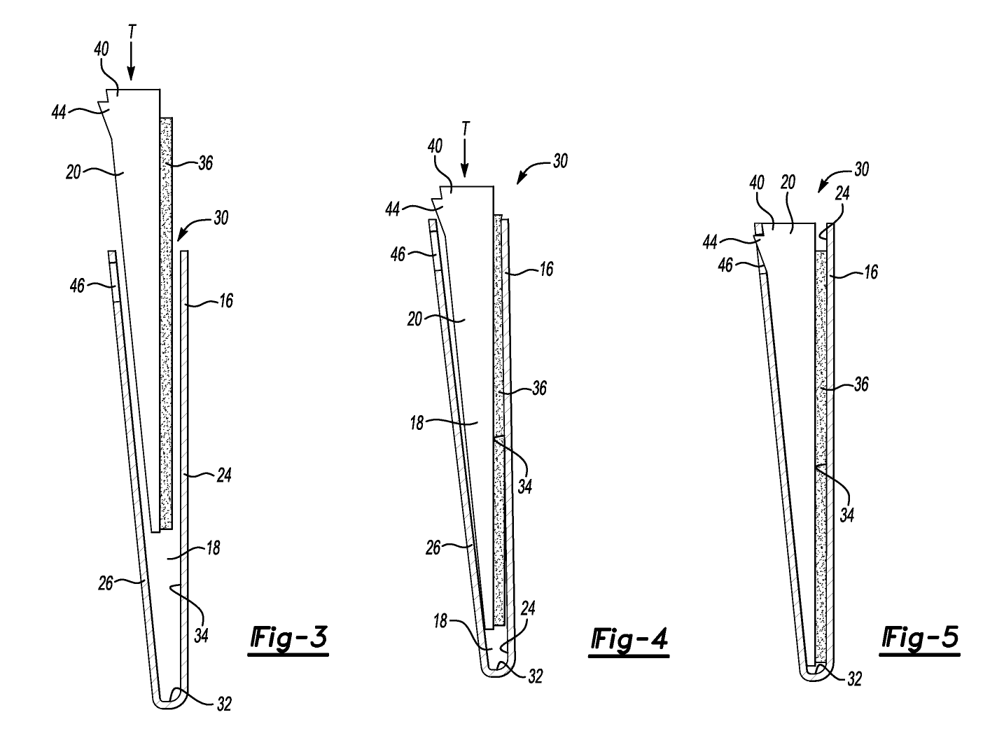

Referring to FIGS. 3-5, the receptacle 16 that defines the V-shaped slot 18 is shown in the process of receiving the fitting 20 within the V-shaped slot 18. The receptacle 16 is formed by the inner wall 24 and outer wall 26 defining the V-shaped slot 18. The inner wall 24 may also be referred to as a sealing flange. The outer wall 26 may also be referred to as a holding flange. The outer wall 26 guides the fitting 20 into engagement with the outer wall 24 as the fitting 20 moves in the transverse direction T. A fitting insertion opening 30 is provided on one lateral side of the V-shaped slot 18. A fitting seat 32 is provided on the opposite lateral side relative to the fitting insertion opening 30. As shown in FIG. 3, the fitting 20 is partially disposed within the fitting insertion opening 30 and is in the process of being moved toward the fitting seat 32.

A face wall 34 of the fitting 20 faces the inner wall 24 of the receptacle 16. An elastomeric seal 36 is attached to the face wall 34 so that the seal is compressed as the fitting 20 is moved into the V-shaped slot 18. The elastomeric seal may be omitted or a different type of sealing material may be used. As shown in FIG. 4, the seal 36 is beginning to be compressed against the inner wall 24. The outer wall 26 shifts the fitting 20 towards the inner wall 24 in the sequence of views including FIGS. 3-5. In FIG. 5, the fitting 20 is fully received in the V-shaped slot 18 with the seal 36 being compressed between the face wall 34 and the inner wall 24.

A first triangular side wall 40 is shown in FIGS. 3-5 that extends perpendicular to the face wall 34. As shown in FIGS. 1 and 2, a second triangular side wall 42 is provided on the opposite side of the fitting 20 from the first triangular side wall 40. The triangular side walls 40, 42 are received between the spacing walls 28.

A locking tab 44 is provided on the first triangular side wall 40 and on the second triangular side wall 42. The locking tab 44 is adapted to be received in a tab receiver 46, or tab slot, defined by the outer wall 26. Alternative cooperating surface features may be used that may be effective in securing the receptacle 16 and the fitting 20 together. As shown in FIG. 3, the locking tab 44 is not disposed in the tab receiver 46. In FIG. 4, the locking tab 44 is entering the V-shaped slot 18 but has not yet been received in the tab receiver 46. In FIG. 5, the locking tab 44 is fully received in the tab receiver 46 to lock the fitting 20 into the receptacle 16.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle heating, ventilation and air conditioning duct assembly comprising:
a first duct;
a second duct that provides airflow between the first duct and the second duct in a first direction;
a receptacle on a receiving end of the first duct that defines a V-shaped slot;
a fitting on an end of the second duct that is inserted in a transverse direction relative to the first direction into the V-shaped slot.

2. The assembly of claim 1 wherein the receptacle is disposed about a periphery of the first duct and defines an open end of the first duct, and the fitting is disposed about a periphery of the second duct and defines an open end of the second duct.

3. The assembly of claim 1 further comprising a seal attached to the fitting that is placed into engagement with an inner wall of the V-shaped slot of the receptacle when the fitting is inserted into the V-shaped slot.

4. The assembly of claim 3 wherein the V-shaped slot includes an outer wall, and wherein the inner wall and the outer wall of the V-shaped slot define an opening on a fitting insertion side and intersect on a side of the V-shaped slot against which the fitting is disposed when the fitting is fully installed in the V-shaped slot.

5. The assembly of claim 4 wherein the fitting includes a face wall that faces the inner wall of the V-shaped slot when the fitting is inserted into the V-shaped slot, and wherein the seal is provided on the face wall to prevent the airflow from escaping from the V-shaped slot and the fitting.

6. The assembly of claim 5 wherein the seal is an elastomeric seal that is compressed between the inner wall and the face wall as the fitting is inserted into the V-shaped slot by the outer wall of the receptacle.

7. The assembly of claim 1 wherein a locking tab is provided on one of the receptacle and fitting and a tab receiver is provided on the other one of the receptacle and fitting to selectively lock the fitting to the receptacle.

8. The assembly of claim 1 wherein the fitting includes a face wall and two triangular sidewalls that extend between the face wall and an outer wall of the receptacle.

9. The assembly of claim 8 wherein a locking tab is provided on at least one of the sidewalls and an outer portion of the receiver defines a tab slot that receives the locking tab to lock the fitting within the receptacle.

10. The assembly of claim 1 wherein the V-shaped slot defined by the receptacle further comprises a sealing flange that is provided about the first duct, a holding flange oriented at an angle relative a sealing flange, and first and second spacing walls that connect the sealing flange to the holding flange.

11. A heating ventilation and air conditioning system duct joint assembly comprising:
a first tubular duct;
a second tubular duct that conducts airflow between the first tubular duct and the second tubular duct;
a receptacle on a receiving end of the first tubular duct that includes an inner wall that extends about a first end of the first tubular duct, an outer wall connected to the inner wall on a first lateral side and spaced from the inner wall on a second lateral side to define a slot that is closed at the first lateral side and is open on the second lateral side;
a fitting on an end of the second duct that is inserted into the slot through the second lateral side.

12. The duct joint assembly of claim 11 wherein the receptacle is disposed about a periphery of the first duct and defines an open end of the first duct, and the fitting is disposed about a periphery of the second duct and defines an open end of the second duct.

13. The duct joint assembly of claim 11 further comprising a seal attached to the fitting that is placed into engagement with an inner wall of the slot of the receptacle when the fitting is inserted into the slot.

14. The duct joint assembly of claim 13 wherein the slot includes an outer wall, and wherein the inner wall and the outer wall of the slot define an opening on a fitting insertion side and intersect on a side of the slot against which the fitting is disposed when the fitting is fully installed in the slot.

15. The duct joint assembly of claim 14 wherein the fitting includes a face wall that faces the inner wall of the slot when the fitting is inserted into the slot, and wherein the seal is provided on the face wall to prevent the airflow from escaping from the slot and the fitting.

16. The duct joint assembly of claim 15 wherein the seal is an elastomeric seal that is compressed between the inner wall and the face wall as the fitting is inserted into the slot by the outer wall of the receptacle.

17. The duct joint assembly of claim 11 wherein a locking tab is provided on one of the receptacle and fitting and a tab receiver is provided on the other one of the receptacle and fitting to selectively lock the fitting to the receptacle.

18. The duct joint assembly of claim 11 wherein the fitting includes a face wall and two triangular sidewalls that extend between the face wall and the outer wall of the receptacle.

19. The duct joint assembly of claim 18 wherein a locking tab is provided on at least one of the sidewalls and the outer wall defines a tab slot that receives the locking tab to lock the fitting within the receptacle.

20. The duct joint assembly of claim 11 wherein the slot defined by the receptacle further comprises a sealing flange that is provided about the first duct, a holding flange oriented at an angle relative a sealing flange, and first and second spacing walls that connect the sealing flange to the holding flange.
